(19) United States
(12) Patent Application Publication
(10) Pub. No.: US 2021/0122168 A1
(43) Pub. Date: Apr. 29, 2021

(54) APPARATUS AND METHOD FOR MARKING OBJECTS ON DIFFERENT FACES

(71) Applicant: HBM2 LIMITED, Mellieha (MT)

(72) Inventor: Maurizio CUCCHI, Leggiuno Varese (IT)

(73) Assignee: HBM2 LIMITED, Mellieha (MT)

(21) Appl. No.: 17/051,042

(22) PCT Filed: Apr. 12, 2019
(86) PCT No.: PCT/EP2019/059455

§ 371 Date: Oct. 27, 2020

(30) Foreign Application Priority Data
Apr. 27, 2018 (EP) 18169921.6

(51) Int. Cl. B41J 2/44; B41J 3/407

(52) U.S. Cl. CPC B41J 2/442; B41J 3/4073

(57) ABSTRACT

The present invention is directed to an apparatus and to a method for laser marking an object on different faces having different orientation. In a preferred embodiment the present invention is directed to an apparatus and a method for laser marking embedding cassettes on different faces thereof. The apparatus according to the invention comprises a laser source, two minors (galvo mirrors) capable to angularly deflect the laser beam, and at least one deflection mirror for each face of the polyhedron to be laser marked. The laser beam, downstream of the two minors, passes through a focus lens named “flat field lens” or “F-theta”, and optionally through a dynamic Z axis, which has the peculiarity of enlarging and shortening the light path between the target itself and the laser focal point, with the task of maintaining the focal point adherent to the plane surface to be marked, along the whole area of angular stroke of the two minors.

### FIELD OF THE INVENTION

The present invention is directed to an apparatus and a method for laser marking of an object on different faces and having different orientation. In a preferred embodiment, the present invention is directed to an apparatus and a method for laser marking embedding cassettes on different faces thereof.

### BACKGROUND OF THE INVENTION

Laser marking is becoming increasingly common. Particularly, it is known in the art the use of a laser beam for embossing or changing colour of metallic or plastic parts.

US 2003/0049178 discloses an apparatus for laser marking embedding cassettes made of plastic material, the apparatus comprising a printing head for marking plastic surfaces positioned in front of it and a gripping means for grasping and subsequently releasing an embedding cassette. The printing head can be rotated with respect to an axis of rotation in a way that it always faces the oblique side of the cassette, but not the lateral faces adjacent to the oblique side.

WO 2012/159762 discloses an apparatus for laser marking histological cassettes, which apparatus comprises a printing head and gripping means for rotating the cassettes and presenting to the printing head three different faces of the cassette, the oblique face and two adjacent faces. The movement of the gripping elements takes place through different motors, the presence of which makes the apparatus expensive. Moreover, the rotation of the cassette to place each of the three faces sequentially in front of the printing head slows down the printing process significantly.

It is therefore desirable the development of a new printing apparatus to print on different faces of a polyhedron in a simpler and more economical way.

### SUMMARY OF THE INVENTION

The present invention solves the above indicated problem by providing a laser apparatus capable of printing on different faces of a polyhedron without using motors to rotate the polyhedron itself. Particularly, the present invention provides a printer capable of performing laser marking of a polyhedron on any face of the polyhedron itself, thanks to the presence of reflection means orientating the laser beam on the different faces to be printed on the polyhedron. In this way it is possible to mark a multifaceted object on different faces while holding it still in a predetermined position. The printing process therefore takes place very quickly, since the laser beam movement is much faster than the movement of the polyhedron. Furthermore, the apparatus according to the invention is less expensive than the state of the art and requires less maintenance due to the presence of less parts subjected to wear.

### DESCRIPTION OF FIGURES

FIG. 1 shows the operation of the galvo mirrors 110 and the possibility of movement of the laser beam with a conventional system.

FIG. 2 shows the positioning of a polyhedron (in the specific case a cube) facing the laser beam.

FIG. 3 shows a device according to the invention wherein the laser beam, once passed through the lens 120, is deflected by mirrors 130 and perpendicularly hits the surface to be marked.

FIG. 4 shows an embedding cassette 200 marked on at least two sides by an apparatus according to the invention.

FIG. 5 shows the schematic diagram of a device according to the invention while marking an embedding cassette.

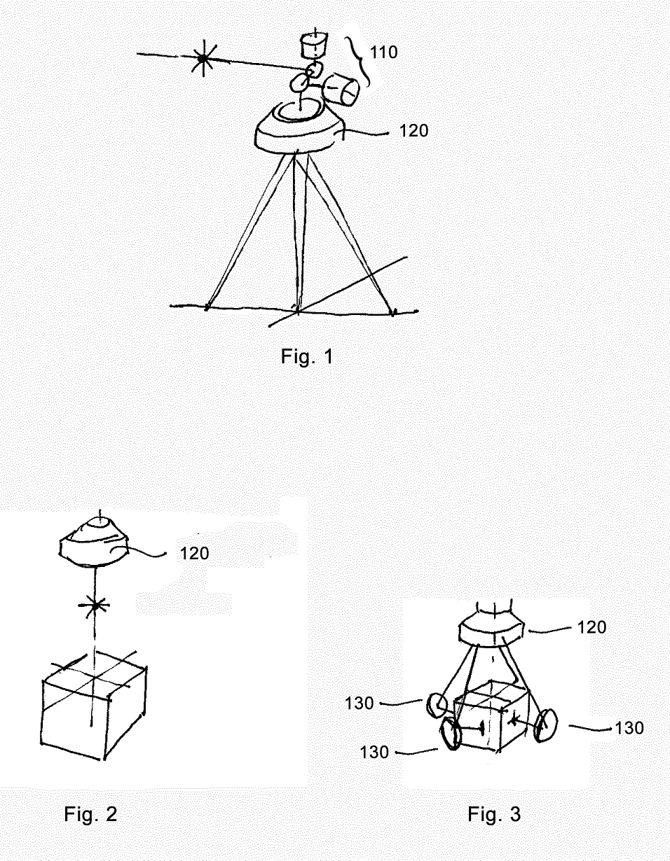

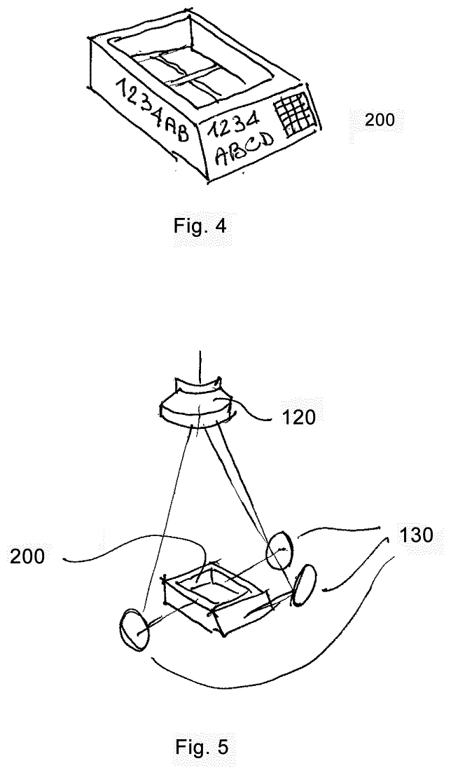

### DETAILED DESCRIPTION OF THE INVENTION

The apparatus according to the invention comprises a laser source, two mirrors (galvo mirrors) capable of deflecting the laser beam, and at least one deflection mirror for each face of the polyhedron to be laser marked. The laser beam, downstream of the two galvo-mirrors, passes through a focusing lens named “flat field lens” or “F-theta”, which has the peculiarity of lengthening and shortening the light path between the objective itself and the laser focal point, in order to maintain the focal point adhering to the plane surface to be marked, along the entire angular excursion of the two mirrors within the tolerance called “depth of field”.

After passing through the flat field lens, the deflected beam reaches one of the deflection beam surfaces which allow to mark a face of polyhedron.

In the example of FIG. 3, it is shown the schematic diagram of an apparatus according to the invention for the marking of the four perimeter faces of a cube having one of its three orthogonal axes matching with the axis of the F-theta lens. The four mirrors suitable for reflecting the laser beam impacting with angle of incidence straddling 45°, with a tolerance of up to ±15%, are placed into space in such a positions and a fixed orientation to deflect the laser beam impacting on them, thus to direct it towards the surface to be marked; the axes of the reflected beam forms with the surface to be marked an angle of about 90°, with minimum tolerance so as to avoid distortion of the marked image with respect to the original file.

In the specific case of embedding cassettes, they are marked on at least two faces, preferably at least three faces, e.g. four lateral faces of a polyhedron. The apparatus according to the invention therefore foresees two reflection means, preferably at least three, for example four, for bringing the laser beam on the at least two, at least three or four faces to be marked.

The deflection of the laser beam by the galvo-mirrors is limited to a design-defined angle; said limitation imposes a consequent limitation of the operating range of the laser beam.

The apparatus according to the invention is therefore able to carry out the marking on the different faces of the polyhedron according to two embodiments.

In a first embodiment, the position of the reflection means is chosen in a way that the optical path of the laser beam to reach the different faces of polyhedron has a substantially equal length. In this way, the focus can be achieved on the surface of each face. In this embodiment, the optical path from the F-theta lens to the reflection means up to the face to be marked is fixed and defined by the optical characteristics of the system; this constitutes a constant for the system under consideration, except for the tolerance called “depth of field” that is a dimension determined by the rules of optical transmission and by luminance of the used laser beam.

It is therefore possible, starting from the calculation of the longest optical path, that is, in general the optical path to reach the face of the farthest furrow with respect to the print head, by adding reflecting elements to lengthen the optical path to reach the nearest faces.

In a second embodiment, it is possible to correct the focusing of each single ray for the marking of each face of the polyhedron by the use of a dynamic Z axis, that is a set of lens placed between the laser source and the printing head, capable of adapting the focal distance of the beam between a minimum and a maximum value. In this embodiment, the geometry of the reflection means can be drawn with greater freedom, since the dynamic Z axis is able, within defined limits, to lengthen or shorten the focal distance.

FIG. 5 shows the case of marking embedding cassettes according to the first embodiment, in which the position of the reflection mirrors is chosen in such a way that the length of the optical path of the three beams is equal. Particularly, two faces to be marked are perpendicular to F-theta lens plane, while one face is inclined.

When the laser printer according to the invention is a laser printer for embedding cassettes, it preferably comprises at least one hub to feed the printing position; conveyor means for bringing the cassettes from the hub to the printing position; a printing head; release means for bringing the cassette from printing position to the user or to a collection system.

The at least one hub contains cassettes for printing. Preferably, the printer according to the invention comprises a plurality of hubs; for example, each hub hosts cassettes of different colour and/or dimension.

The movement of the cassettes from the at least one hub to printing position, is preferably carried out through at least one pusher slide sliding along a tray. Alternatively, the cassette can reach the printing position by drop, by means of a robotic arm or by extraction using a stop gate.

Once the printing position is reached, the information is printed on the cassette by means of a laser head equipped with a reflection system as described above.

In a preferred embodiment, the printer also comprises a means to verify the correctness and the readability of the print job, as described in European Patent Application EP 18 164 857.7, herewith incorporated by reference.

The mean to verify the correctness and the readability of the print job can be a simple bar code reader. In this case anyhow, the amount of readable information is limited to those included in the barcode. A larger amount of data can be verified using a camera. Preferably, the printer according to the invention comprises a camera, even more preferably a colour camera.

In fact, a colour camera allows to record also the colour of the embedding cassette. As previously stated, the colour of the cassette is often used as a distinctive element to indicate the type of biological sample contained in the cassette, or the year of use. Thus, the colour registration of the image also allows the retention of this information.

Once the print job is completed, the cassette undergoes the validation process by camera or a barcode reader and, if validation is successful, the cassette is released and made available to the operator. In case of a negative result, the cassette is discarded through a dedicated chute and the printer prints a new cassette with the same print information as the discarded one.

Preferably the validation takes place on each individual face immediately after the printing. Then, after printing the first face, the correctness of the print job is verified and if it is correct, the printer starts printing the second face, and so on. In this way, it is avoided that, in the presence of an error, other faces of the cassette are printed.

If the validation is successful, the cassette is released and made available in various ways. In one embodiment of the invention, the cassette is released by falling onto a sliding tray which transports the cassette to the operator. In the case of a printer shared between two or more operators, it is possible that the printer chooses, on the basis of the information received, the operator to whom the cassette is delivered, thanks to the presence of two or more sliding trays, each of which connected to a different operator.

At last it is possible to release the cassette in a horizontal collector placed under the printing position. In this case the release generally takes place by fall and the collector preferably contains up to 30 cassettes.

1. Laser printer for marking three-dimensional objects on at least two faces having different orientation, said printer comprising:
a. a laser source;
b. two galvo mirrors capable to angularly deflect a laser beam from the laser source;
c. a flat field lens; and
d. at least one deflection mirror per each face of a polyhedron which is intended to mark.

2. Laser printer according to claim 1, wherein the three-dimensional object is an embedding cassette.

3. Printer according to claim 1, wherein the faces to be marked are at least 3.

4. Printer according to claim 3, wherein the faces to be marked are 4.

5. Printer according to claim 1 wherein a length of an optical path of the laser beam is substantially equal for the different faces to be marked.

6. Printer according to claim 5, wherein the difference amongst optical paths for each of the faces to be marked is lower than or equal to a depth of field of the laser beam that is used.

7. Printer according to claim 1, further comprising a dynamic Z axis.

8. Printer according to claim 2, further comprising at least one hub to feed the printing position; conveyor means to transport the embedding cassette from the hub to the printing position; release means to bring the embedding cassette from the printing position to at least one user or to a collection system.

9. Printer according to claim 8, wherein the at least one hub consists of a plurality of hubs.

10. Printer according to claim 9, wherein each hub hosts cassettes of different colour and/or dimension.

11. Printer according to claim 1, further comprising a control means to verify the correctness and readability of a print job.

12. Printer according to claim 11, wherein the control means is selected from a barcode-reader, a camera, and a colour camera.

13. Method for marking three-dimensional objects on several faces having different orientation, which method comprises subjecting the object to a print job by a laser printer comprising:
a. a laser source;
b. two galvo mirrors capable to angularly deflect a laser beam from the laser source;
c. a flat field lens; and
d. at least one deflection mirror per each face of a polyhedron which is intended to mark.

14. Method according to claim 13, wherein the three-dimensional object is an embedding cassette.

15. Method according to claim 13, wherein the faces to be marked are at least 3.

16. Method according to claim 13, wherein the faces to be marked are 4.

17. Method according to claim 13, wherein a length of an optical path of the laser beam is substantially equal for each of the faces to be marked.

18. Method according to claim 17, wherein the difference amongst the optical path for the each of the faces to be marked is lower than or equal to a depth of field of the laser beam that is used.

19. Method according to claim 13, further comprising a dynamic Z axis.

20. Method according to claim 14, further comprising at least one hub to feed the printing position; conveyor means to transport the embedding cassette from the hub to the printing position; release means to bring the embedding cassette from the printing position to at least one user or to a collection system.

21. Method according to claim 20, wherein the at least one hub consists of a plurality of hubs.

22. Method according to claim 21, wherein each hub hosts cassettes of different colour and/or dimension.

23. Method according to claim 13, further comprising verifying the correctness and readability of a print job.

24. Method according to claim 23, wherein verifying the correctness and readability of the print job is performed by a means selected from a barcode-reader, a camera, and a colour camera.
